(19) United States
(12) Patent Application Publication
(10) Pub. No.: US 2009/0086068 A1
(43) Pub. Date: Apr. 2, 2009

(54) SOLID-STATE IMAGE PICK-UP DEVICE AND IMAGE PICK-UP APPARATUS

(76) Inventors: Tatsuya Hagiwara, Miyagi (JP); Tomohiro Sakamoto, Miyagi (JP)

Correspondence Address: BIRCH STEWART KOLASCH & BIRCH, PO BOX 747, FALLS CHURCH, VA, 22040-0747, US

(21) Appl. No.: 12/239,653

(22) Filed: Sep. 26, 2008

(30) Foreign Application Priority Data
Sep. 28, 2007 (JP) P2007-256702
Sep. 24, 2008 (JP) P2008-244425

(51) Int. Cl. H04N 5/335

(52) U.S. Cl. 348/294

(57) ABSTRACT

A solid-state image pickup device includes plural photo sensitive elements. The plurality of photosensitive elements are arranged to form a matrix pattern. The photosensitive elements include first photosensitive elements that obtain simultaneously brightness components and hue components; and second photosensitive elements that obtain hue components. The second photosensitive elements are hue photosensitive elements. And the number of the first photosensitive elements is equal to that of the hue photosensitive elements.

### CROSS-REFERENCE TO RELATED APPLICATIONS

This application is based on and claims priority under 35 USC 119 from Japanese Patent Application No. 2007-256702 filed Sep. 28, 2007 and Japanese Patent Application No. 2008-244425 filed Sep. 24, 2008; the entire of which are incorporated herein by reference.

### BACKGROUND

1. Technical Field

This invention relates to a solid-state image pickup device and an image pickup apparatus capable of giving the brightness component with a high resolution.

2. Related Art

A checkered pattern of sampling points of photosensitive elements for extracting the brightness component has been proposed to the brightness component with high resolution from a solid-state image pickup device.

The solid-state image pickup device disclosed in Patent Reference 1 (JP-A-2003-318375) includes brightness filters and color filters arranged to form the checkered pattern on a light receiving area, respectively. In using this solid-state image pickup device, the brightness component and color component are discriminately detected from the brightness filters and color filters so that the brightness resolution not depending on the color information and color reproduction not depending on the spectral characteristic can be obtained.

However, in the image pickup device disclosed in Patent Reference 1, the color reproducibility and color resolution may be deteriorated for the following reason. Namely, since the brightness filters fetch all items of the color information in the photo-electric conversion unit of the image pickup device, for example, where a very bright object is picked up, a great increase in the charges stored in the photo-electric conversion unit makes it difficult to do appropriate brightness adjustment and simultaneously the phenomenon of flowing of the charges stored into an adjacent vertical transfer unit generates color-mixing. In order to obviate such an inconvenience, where a bright object is picked up, measures such as changes in exposure setting must be done. Further, from the light receiving area where the brightness filters are arranged, the color information cannot be obtained so that reduction in the color reproducibility is inevitable as compared with the image pickup device in which the color filters are arranged on the entire light receiving area.

This invention has been accomplished in view of the above circumstances. An object of this invention is to provide a solid-state image pickup device capable of improving the resolution of a brightness component without substantially deteriorating color reproducibility and color resolution. Another object of this invention is to provide an image pickup apparatus with less limitation during image pickup.

### SUMMARY

[1] According to an aspect of the invention, a solid-state image pickup device includes a plurality of photosensitive elements arranged to form a matrix pattern. The photosensitive elements includes: first photosensitive elements that obtain simultaneously brightness components and hue components; and hue photosensitive elements that obtain hue components.

[2] According to the solid-state image pickup device of [1], the first photosensitive elements may be arranged with a uniform density.

[3] According to the solid-state image pickup device of [1], each first photosensitive element may have a spectral sensitivity over the entire visible light range, and each first photosensitive element may obtain the spectral sensitivity higher for green than for other colors.

[4] According to the solid-state image pickup device of [1], the hue photosensitive elements maybe a plurality of kinds of photosensitive elements with different spectral sensitivities.

[5] According to the solid-state image pickup device of [4], the plurality of kinds of photosensitive elements may include a photosensitive element having a spectral sensitivity for magenta and a photosensitive element having the spectral sensitivity for yellow.

[6] According to the solid-state image pickup device of [4], the plurality of kinds of photosensitive elements may include a photosensitive element having a spectral sensitivity for red, a photosensitive element having the spectral sensitivity for green and a photosensitive element having the spectral sensitivity for blue.

[7] According to the solid-state image pickup device of [4], the plurality of kinds of photosensitive elements may include a photosensitive element having a spectral sensitivity for green, a photosensitive element having the spectral sensitivity for cyan, a photosensitive element having the spectral sensitivity for magenta and a photosensitive element having the spectral sensitivity for yellow.

[8] According to the solid-state image pickup device of [1], the hue photosensitive elements may be photosensitive elements which sense light through color filters. The first photosensitive elements may be photosensitive elements which sense light through color filters of the same material as any one of the color filters of the first photosensitive elements. The film thickness of the color filter of each first photosensitive element is thinner than the color filter of each hue photosensitive element.

[9] According to the solid-state image pickup device of [1], the number of the first photosensitive elements may be equal to that of the hue photosensitive elements.

[10] According to the solid-state image pickup device of [9], the plurality of photosensitive elements may be arranged to form a square lattice pattern. The first photosensitive elements may be arranged at checking positions of the square lattice pattern.

[11] According to the solid-state image pickup device of [9], the first photosensitive elements and the hue photosensitive elements may be arranged to form square lattice patterns at equal pitches, respectively, and the respective square lattice patterns may be shifted from each other in the row and column directions by a ½ pitch.

[12] According to the solid-state image pickup device of [1], the solid-state image pickup device may be a MOS type solid-state image pickup device.

[13] According to the solid-state image pickup device of [1], the solid-state image pickup device may be a CCD type solid-state image pickup device.

[14] An image pickup apparatus may include the solid-state image pickup device of [1].

[15] According to The image pickup apparatus of [14], an autofocus operation may be performed with signals obtained from the first photosensitive elements and without signals obtained from the hue photosensitive elements.

As understood from the above description, according to [1] to [15], there is provided a solid-state image pickup device capable of improving the resolution of a brightness component without substantially deteriorating color reproducibility and color resolution and giving less limitation during image pickup.

### BRIEF DESCRIPTION OF THE DRAWINGS

FIG. 1 is a view showing the schematic configuration of a digital camera which is an example of the image pickup apparatus according to an embodiment of this invention.

FIG. 2 is a schematic view of a light receiving area surface of the solid-state image pickup device according to a first embodiment of this invention.

FIG. 3 is a graph showing an example of the spectral characteristics of filters provided on the solid-state image pickup device according to the first embodiment of this invention.

FIG. 4A and FIG. 4B are schematic sectional views of an example of the solid-state image pickup device according to the first embodiment of this invention.

FIGS. 5A and FIG. 5B are views showing another example of the solid-state image pickup device according to the first embodiment of this invention.

FIG. 6A and FIG. 6B are views showing still another example of the solid-state image pickup device according to the first embodiment of this invention.

FIG. 7A and FIG. 7B are views showing the process of manufacturing color filters in the first embodiment of this invention.

FIG. 8A, FIG. 8B, FIG. 8C, FIG. 8D and FIG. 8E are views showing the process of manufacturing color filters in the first embodiment of this invention.

FIG. 9A, FIG. 9B, FIG. 9C, FIG. 9D and FIG. 9E are views showing the process of manufacturing color filters in the first embodiment of this invention.

FIG. 10A, FIG. 10B and FIG. 10C are views showing the process of manufacturing color filters in the first embodiment of this invention.

FIG. 11A, FIG. 11B and FIG. 11C are views showing the process of manufacturing color filters in the first embodiment of this invention.

FIG. 12A, FIG. 12B and FIG. 12C are views showing the process of manufacturing color filters in the first embodiment of this invention.

FIG. 13 is a schematic view of a light receiving area surface of the solid-state image pickup device according to a second embodiment of this invention.

FIG. 14 is a schematic view of a light receiving area surface of the solid-state image pickup device according to a third embodiment of this invention.

FIG. 15 is a schematic view of a light receiving area surface of the solid-state image pickup device according to a fourth embodiment of this invention.

FIG. 16 is a schematic view of a light receiving area surface of the solid-state image pickup device according to a fifth embodiment of this invention.

FIG. 17 is a schematic view of a light receiving area surface of the solid-state image pickup device according to a sixth embodiment of this invention.

FIG. 18A and FIG. 18B are views showing the configuration of a concrete example of a MOS-type color image pickup device according to an embodiment of this invention.

FIG. 19A and FIG. 19B are views showing the configuration of a concrete example of a CCD-type color image pickup device according to an embodiment of this invention.

### DETAILED DESCRIPTION

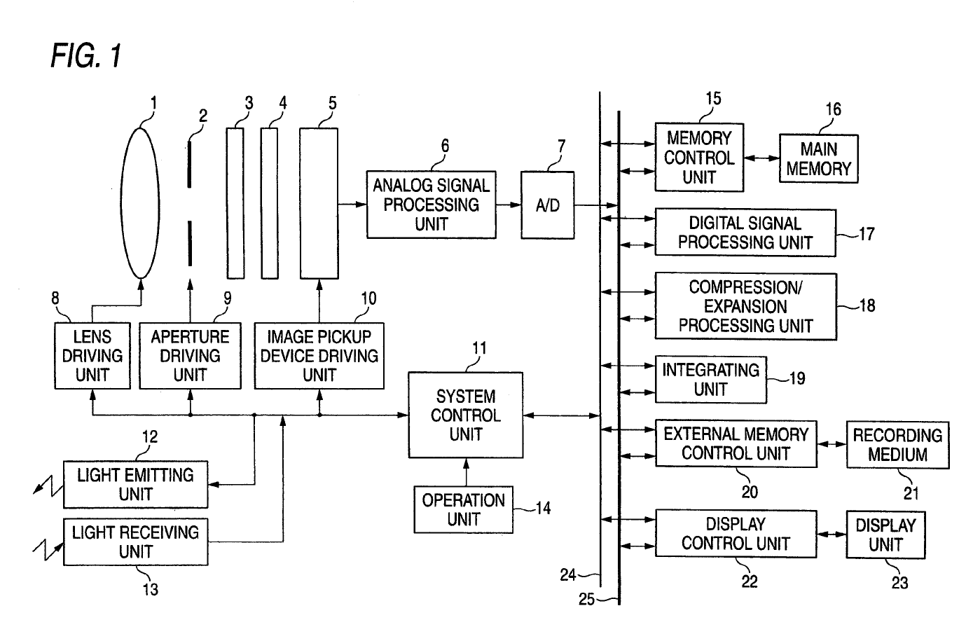

FIG. 1 is a view showing the schematic configuration of a digital camera which is an example of the image pickup apparatus according to an embodiment of this invention. The image pickup system of the digital camera illustrated includes an image pickup lens 1, a CCD type solid-state image pickup device 5, an aperture 2 located therebetween, an infrared ray cutting filter 3 and an optical low-pass filter 4. The details of the solid-state image pickup device 5 will be described later.

A system control unit 11 for centrally controlling the entire electric control system of the digital camera controls a flash light emitting unit 12 and a light receiving unit 13, controls a lens control unit 8 to adjust the position of the pickup lens 1 and make zooming adjustment, and controls the opening rate of the aperture 2 through an aperture driving unit 9 to adjust light exposure.

Further, the system control unit 11 drives the solid-state image pickup device 5 through an image pickup device driving unit 10 to output an object image through the image pickup lens 1 as a color signal. An instruction from a user is supplied to the system control unit 11 through an operation unit 14.

The electric control system of the digital camera further includes an analog signal processing unit 6 for executing analog signal processing such as correlated double sampling processing, connected to an output of the solid-state image pickup device 5, and an A/D conversion unit 7 for converting the signal outputted from the analog signal processing unit 6 into a digital signal. These units are controlled by the control unit 11.

Further, the electric control system of the digital camera includes a main memory 16; a memory control unit 15 connected to the main memory 16; a digital signal processing unit 17 for executing an interpolation operation, gamma correction operation and RGB/YC conversion processing to create image data; a compression/expansion processing unit 18 for compressing the image data created by the digital signal processing unit 17 into a JPEG format or expanding the compressed image data; an integrating unit 19 for integrating photometric data to acquire the gain of white balance correction executed by the digital signal processing unit 17; an external memory control unit 20 to which a removable recording medium 21 is connected; and a display control unit 22 to which a liquid-crystal display unit 23 loaded e.g. on the rear of the camera is connected. These units are connected to one another by a control bus 24 and a data bus 25 and controlled by instructions from the system control unit 11.

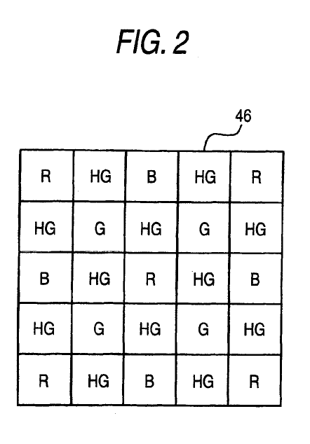

FIG. 2 is a schematic view of a light receiving area surface of the solid-state image pickup device according to a first embodiment of this invention. FIG. 2 illustrates only the range of five rows and five columns, but, in an actual structure, the arrangement illustrated is repeated vertically and horizontally.

The light receiving area 46 of the solid-state image pickup device according to this embodiment includes high sensitivity G filters HGs and color filters R, G, B formed on the individual surfaces of a large number of photodiodes (not shown) formed from a matrix in a square lattice pattern (It should be noted that the surface illustrated represents not only that the filters are directly formed on a semiconductor substrate surface but also that they are formed apart by a predetermined interval from the surface. This also applies to the following description). The high sensitive G filters HGs are formed on the surfaces of the photodiodes located at the checking positions of the square lattice pattern of the individual photodiodes of the matrix. The color filters R, G. B are formed above the surfaces of the photodiodes located at the remaining positions of the square lattice pattern. The number of the high sensitivity G filters HGs is equal to the number of the color filters (R, G, B) (total of R, G, B). The “equal” here is not strictly defined but also means that according to the layout on the periphery of the photosensitive elements, the density or number of the high sensitivity G filters HGs and that of the color filters (R, G, B) are not accurately equal. In the following description, as the case may be, red, green and blue are simply referred to as R, G, B.

In the solid-state image pick-up device 1 illustrated in FIG. 2, on the individual surfaces of the photodiodes at even rows, the filters lined up like “HG, G, HG, G, . . . ” are arranged whereas on the individual surfaces of the photodiodes at odd rows, the filters lined up like “R, HG, B, HG, R, . . . ” and the filters lined up like “B, HG, R, HG, B, . . . ” are alternately arranged.

The filter HG is a filter which passes light in the entire visible light range and whose transmittance of green light is higher than that of other color lights. Therefore, the photodiode below the high sensitivity G filter HG has a spectral sensitivity over the entire visible light range and provides a spectral sensitivity which is higher for green than for the other colors. Thus, it can simultaneously provide the hue component of G and the brightness component. The color filters R, G and B are filters which pass red light, green light and blue light, respectively. Therefore, the photodiodes below the color filters R, G and B serve as hue sensitive elements having the spectral sensitivities for red, green and blue, respectively.

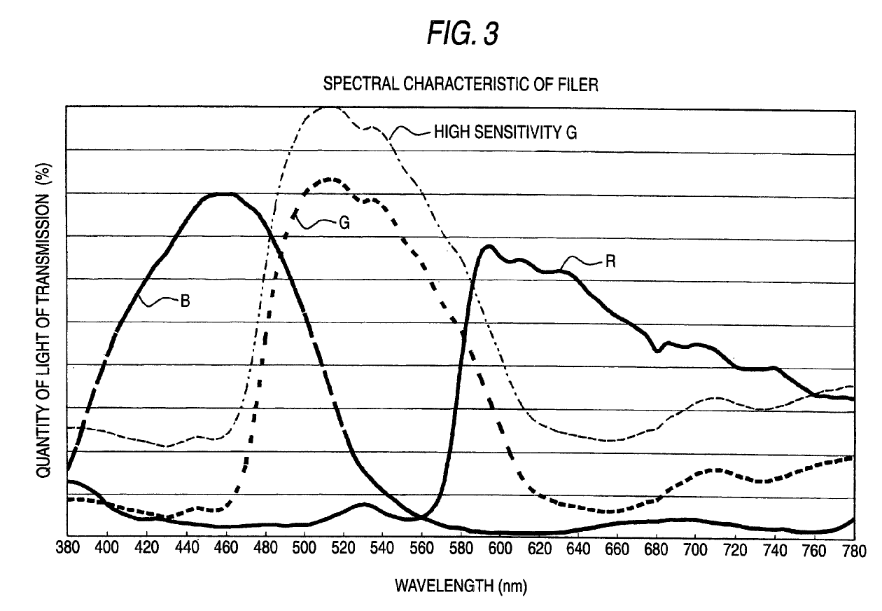

FIG. 3 is a graph showing an example of the spectral characteristics of the high sensitivity G filter HG and color filters R, G and B. In the visible light range, the color filters R, G and B have the characteristics which pass red light, green light and blue light, respectively. The high sensitivity G filter HG has the characteristic entirely shifted from that of the color filter G, which provides more quantity of transmission of green light than the color filter G and also passes the light of the other colors.

Since the high sensitivity G filter has the characteristic as shown in FIG. 3, the photodiode located therebelow can simultaneously provide the brightness component and hue component. Further, since the high sensitivity G filter reduces the transmission quantity of light of colors other than green light, it serves as a filter capable of suppressing excessive flow-in of charges stored in the photodiode of a photo-electric converting portion, which occurs when a very bright object is picked up. Thus, the high sensitivity brightness component can be obtained without generating deterioration of the color reproducibility and color resolution due to color mixing.

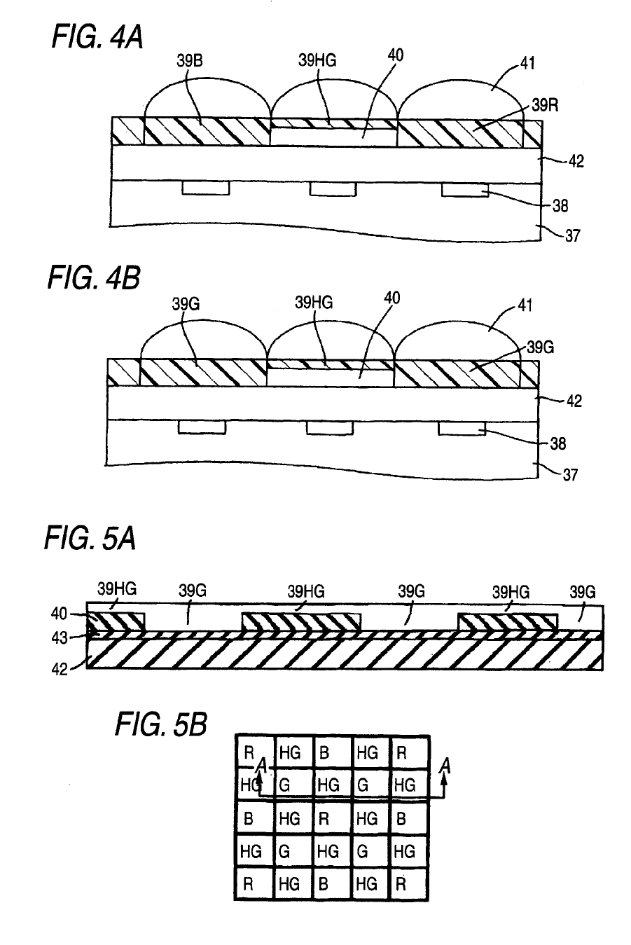

FIG. 4A and FIG. 4B are schematic sectional views of an example of the solid-state image pickup device according to the first embodiment of this invention. FIG. 4A is a schematic sectional view showing the odd row of the solid-state image pickup device of FIG. 2. FIG. 4B is a schematic sectional view showing the even row of the solid-state image pickup device of FIG. 2.

In this solid-state image pickup device, as shown in FIG. 4A and FIG. 4B, photodiodes 38 being the photo-electric converting portions are formed to be arranged in the surface of an n-type Si substrate 37; and above the respective photodiodes 38, high sensitivity G filter 39HG and color filters 39B, 39G, 39R are formed. The high sensitivity G filter 39HG is formed on a translucent area 40. This filter is formed of the material having the same or similar transmission characteristic as that of the color G filter 39. For this reason, it gives more quantity of transmission of green light than the color filter G and also less quantity of blocking of light of the other colors than the color filter G. Thus, this filter gives the characteristic as shown in FIG. 3.

The color filters 39R, 39G and 39B are formed directly on a flattening film 42 of the respective photosensitive elements 38. On the high sensitivity G filter 39HS and color filters 39B, 39G, 39R, micro-lenses 41 are formed, respectively. The resin film constituting the translucent area 40 may be a resist material having permeability for the visible light (for example, available from the C-series produced by FUJI FILM ELECTRONICS MATERIAL CO. LTD) or a thermosetting (non-sensitive) material. Although not shown, on and above the Si substrate 37, there are provided elements, electrodes, wirings, etc. for reading the signal charges photo-electric converted by the photodiodes 38 or signals based on the signal charges.

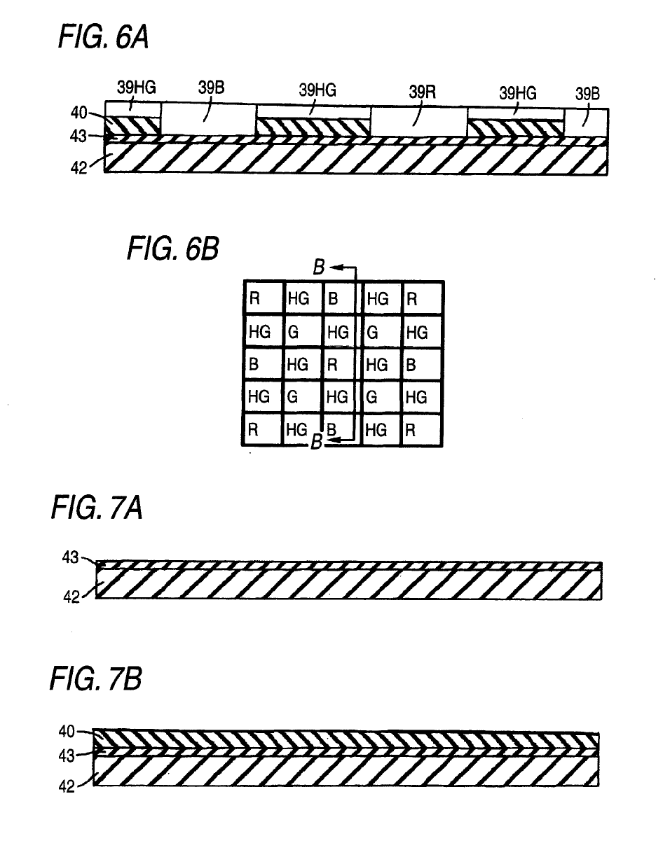

FIG. 5A and FIG. 6A are schematic sectional views of other examples of the solid-state image pickup device according to the first embodiment of this invention. FIG. 5A is a sectional view along line A-A in FIG. 5B and FIG. 6A is a sectional view along line B-B in FIG. 6B. The solid-state image pickup device shown in FIG. 5A, FIG. 5B, FIG. 6A and FIG. 6B is different from that shown in FIG. 4A and FIG. 4B in that the high sensitivity G filter 39HG and color filter 39G are integrally formed of the same material. After the translucent area 40 below the high sensitivity G filter 39HG is accurately patterned by dry etching, the openings thus formed are filled with the same material, thereby giving the high sensitivity G filter 39HG and color filter 39G. In FIG. 5A and FIG. 6A, only the filter portion is illustrated but the semiconductor substrate, micro-lenses, etc. are not illustrated. Further, the film on the flattening film 42 is a passivation film 43.

Next, referring to FIGS. 7A to FIG. 12C, a detailed explanation will be given of the process for manufacturing the color filters in the solid-state image pickup device shown in FIG. 5A and FIG. 6A. In these figures, the red color filter is denoted by “39R”, the green color filter is denoted by “39G”, the blue color filter is denoted by “39B” and the high sensitivity G color filter is denoted by “39HG”. Further, the color filter material of each of R, G, B may be the material which gives a polishing rate of about 1:1 for resist in the CMP processing for flattening. In the following explanation, as the case may be, the green “G” is described as the first color; the red “R” is described as the second color; and the blue “B” is described as the third color. In each of the figures, the layers underlying the flattening film 42 are not shown.

First, as shown in FIG. 7A, after a wiring layer (not shown) is formed on the flattening film 42, a passivation film 43 of a silicon nitride film is formed by plasma CVD. On the passivation film 43, as shown in FIG. 7B, a resin film for forming the translucent area 40 is formed by an applying technique.

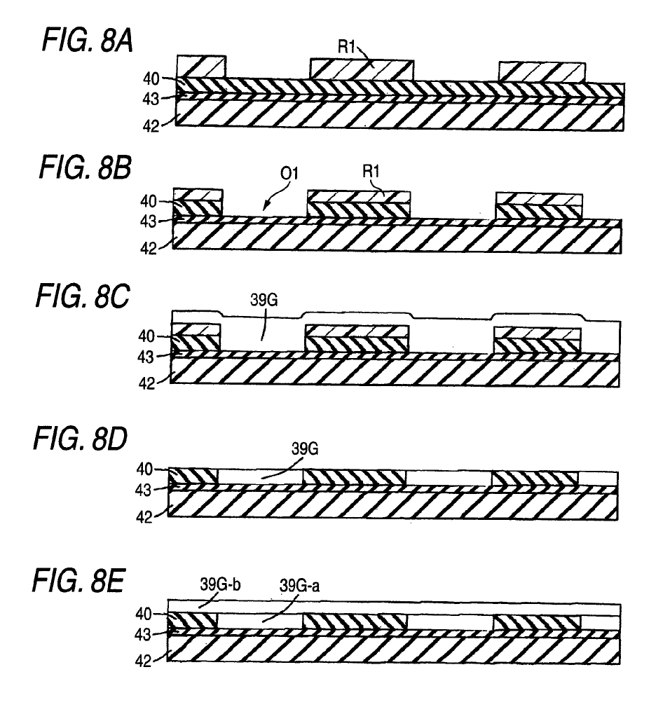

As shown in FIG. 8A, a resist pattern R1 is formed by photolithography. Thereafter, as shown in FIG. 8B, by reactive ion etching (RIE) using the resist pattern R1 as a mask, a first opening O1 is formed. Here, the underlying silicon nitride film 43 serves as an etching stopper. It should be noted that the first opening is formed on only the area where the green color filter 39G is formed.

A green color filter material as the color filter material for the first color is applied to have a thickness of 0.5 to 2.0 μm. It is assumed that this color filter material has photosensitivity. By this step, the green color filter material is filled in the first opening O1 and also applied onto the resist pattern R1. In this state, heat treatment and partial radiation of ultraviolet rays are done to harden only the portion of the green color filter 39G (FIG. 8C). Further, by CMP, the resist pattern R1 on the translucent area 40 and green color filter material are polished to be flattened (FIG. 8D).

As shown in FIG. 8E, the same color filter material as that in FIG. 8C is applied to have a thickness of 0.1 to 1.0 μm. In this state, heat treatment and radiation of ultraviolet rays are done to harden only the portion of the green color filter 39G and portion of the high sensitivity G filter 39HG (above the translucent area 40). Thereafter, CMP may be done to provide a desired film thickness. By this step, the green color filter material is formed on the translucent area 40 and on the green color filter material filled in the opening O1. At this time, the portion of the green color filter above the translucent area 40 is in a hardened state.

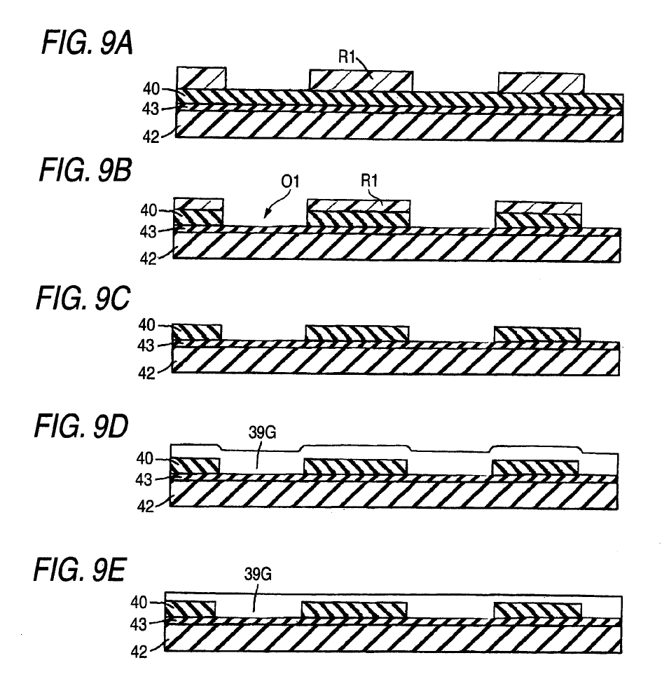

FIGS. 9A to 9E show an embodiment in which the process after the step of FIG. 8C is changed. After the steps of FIG. 9A and FIG. 9B which are the same as those of FIG. 8A and FIG. 8B, the resist pattern R1 is removed using a solvent or under the condition of dry etching (FIG. 9C). Thereafter, as shown in FIG. 9D, the green color filter material is applied on the opening O1 and the translucent area 40. Further, as shown in FIG. 9E, by CMP, the high sensitivity G filter 39HC and the green color filter color filter 39G are formed, respectively. The high sensitivity G filter 39HG and green color filter 39G thus formed are in the hardened state like FIG. 8E. Here, FIGS. 8A to 8E and FIGS. 9A to 9E are sectional views along line A-A in FIG. 5B

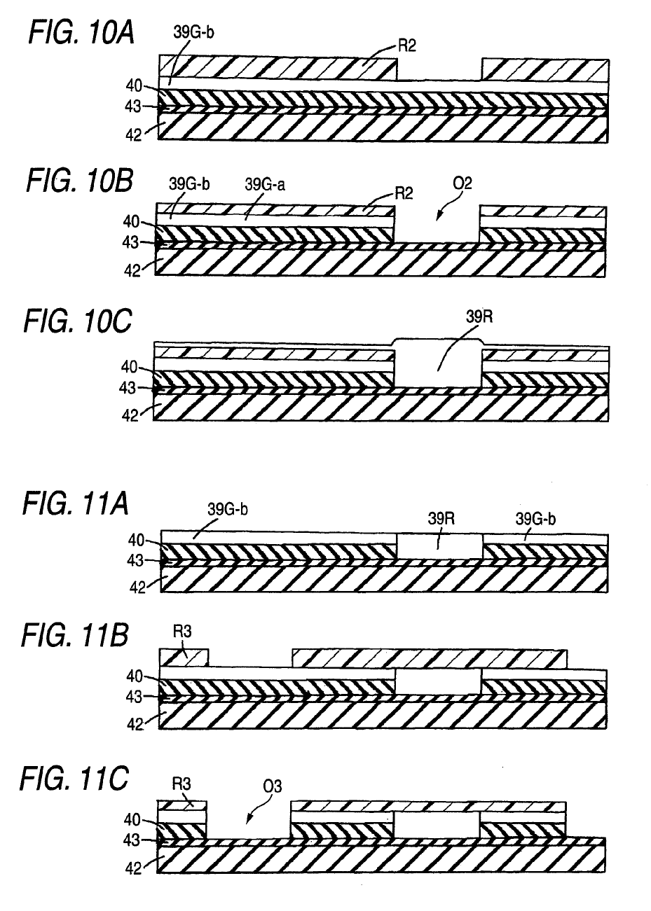

After the step of FIG. 8E or FIG. 9E, as shown in FIG. 10A, a resist pattern R2 for forming a red color filter pattern is formed by photolithography. Here, there is provided a shape having an opening in the area constituting the red color filter.

Thereafter, as shown in FIG. 10B, using the resist pattern R2 as a mask, reactive ion etching (RIE) being anisotropic dry etching is done to form a second opening O2 for forming the pattern of the red color filter material. In this case also, the underlying silicon nitride film 43 serves as an etching stopper.

With the resist pattern R2 being left, a red color filter material is applied to have a thickness of 0.5 to 2.0 μm. In this state, by heat treatment and irradiation of ultraviolet rays, only the portion of a red color filter 39R is hardened (FIG. 10C). Thereafter, by CMP, the surface is flattened to form the red color filter 39R (FIG. 11A).

Thereafter, as shown in FIG. 11B, a resist pattern R3 for forming a blue color filter pattern is formed by photolithography. Here, there is provided a shape having an opening in the area constituting the blue color filter.

Thereafter, as shown in FIG. 11C, using the resist pattern R3 as a mask, reactive ion etching (RIE) being anisotropic dry etching is done to form a third opening O3 for forming the pattern of the blue color filter material. In this case also, the underlying silicon nitride film 43 serves as an etching stopper.

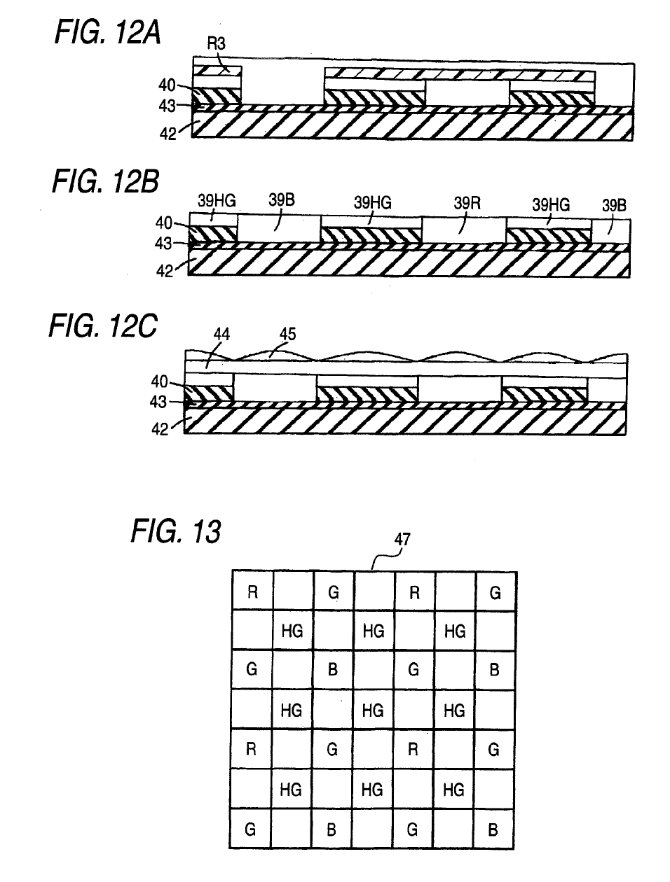

With the resist pattern R3 being left a blue color filter material is applied. In this state, by heat treatment and irradiation of ultraviolet rays, only the portion of a blue color filter 39B is hardened (FIG. 12A). Thereafter, by CMP, the surface is flattened to form the blue color filter 39B (FIG. 12B).

By this CMP processing, the surfaces on the color filters with the respective colors are made flat, and with no residue, a precise color filter pattern can be formed.

Further, on these color filters, a resist material having permeability for the visible light (for example, available from the C-series produced by FUJI FILM ELECTRONICS MATERIAL CO. LTD) is applied to form the flattening film 44. Thereafter, on the flattening film 44, a micro-lens 45 is formed by etching or melting techniques (FIG. 12C). In this way, the solid-state image pickup device as shown in FIGS. 2, 5A (5B) and 6A (6B) is formed.

In addition, the above manufacturing process uses CMP in the flattening process. Other method, such as etch-back, may be used in the flattening process.

FIG. 13 is a schematic view of a light receiving area surface of the solid-state image pickup device according to a second embodiment of this invention. In the image pickup device shown in FIG. 13, the photo-diodes are not arranged to form the square lattice pattern shown in FIG. 2, but to form a checkered pattern. FIG. 13 illustrates only the range of seven rows and seven columns, but actually, in an actual structure, the arrangement illustrated in FIG. 13 is repeated vertically and horizontally.

The light receiving area 47 of the solid-state image pickup device according to this embodiment includes high sensitivity G filters HGs and color filters R, G, B formed on the individual surfaces of a large number of photodiodes (not shown) arranged to form the checkered pattern. This arrangement, when it is inclined obliquely by 45°, becomes an arrangement to form the square lattice pattern; the high sensitive G filters HGs are formed on the surfaces of the photodiodes located at the checking positions of the square lattice pattern inclined obliquely by 45° and the color filters R, G. B are formed above the surfaces of the photodiodes located at the remaining checking positions. Namely, in the solid-state image pickup device illustrated in FIG. 13, in directions of oblique 45°, on the individual surfaces of the photodiodes, “G, HG, G, HG, G, . . . ” and “R, HG, B, HG, R, . . . ” are alternately arranged.

The arrangement of FIG. 13, when viewed from a different aspect, can be regarded as two square lattice patterns at equal pitches has been shifted from each other in the row and column directions by a ½ pitch. In such an aspect, on the surfaces of the photodiodes constituting the one square lattice pattern, the high sensitivity G filters HGs are arranged whereas on the surfaces of the photodiodes constituting the other square lattice pattern, the color filters R, G, B are arranged in the “Bayer” array.

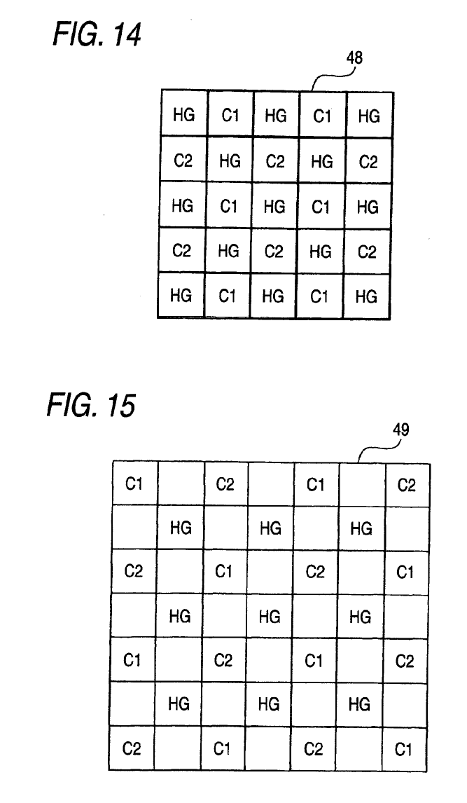

FIG. 14 is a schematic view of a light receiving area surface of the solid-state image pickup device according to a third embodiment of this invention. FIG. 14 illustrates only the range of five rows and five columns, but actually, in an actual structure, the arrangement illustrated in FIG. 14 is repeated vertically and horizontally.

The light receiving area 48 of the solid-state image pickup device according to this embodiment includes high sensitivity G filters HGs and color complimentary filters C1, C2 formed on the individual surfaces of a large number of photodiodes (not shown) formed from a matrix in a square lattice pattern. The high sensitive G filters HGs are formed on the surfaces of the photodiodes located at the checking positions of the individual photodiodes of the matrix. The color filters C1, C2 are formed on the surfaces of the photodiodes located at the remaining checking positions.

Namely, in the solid-state image pick-up device illustrated in FIG. 14, the filters lined up like “HG, C1, HG, C1, HG . . . ” on the individual surfaces of the photodiodes at even rows and the filters lined up like “C2, HG, C2, HG, C2, . . . ” on the individual surfaces of the photodiodes at odd rows are alternately arranged.

The high sensitivity G filters HGs are filters capable of simultaneously giving the brightness component and hue component of G, i.e. brightness/high sensitivity G filters, and allowing a certain quantity of light of the hue components of C1, C2 to pass through. The high sensitivity G filters HGs can be realized by a thin material of the color filter 39G shown in FIG. 4A and 4B.

Further, if it is assumed that the color complement filters C1 and C2 allow magenta and yellow to pass through, respectively, since the hue component of green having the spectral sensitivity is contained over an entire visible light range, the hue information with high sensitivity can be obtained.

FIG. 15 is a schematic view of a light receiving area surface of the solid-state image pickup device according to a fourth embodiment of this invention. In the image pickup device shown in FIG. 15, like that shown in FIG. 13, the photodiodes are arranged to form the checkered pattern. FIG. 15 illustrates only the range of seven rows and seven columns, but actually, the arrangement illustrated in FIG. 15 is repeated vertically and horizontally.

The light receiving area 49 of the solid-state image pickup device according to this embodiment includes high sensitivity G filters HGs and color complementary filters C1, C2 formed on the individual surfaces of a large number of photodiodes (not shown) arranged to form the checkered pattern. This arrangement, when it is inclined obliquely by 45°, constitutes an arrangement to form the square lattice pattern; the high sensitive G filters HGs are formed on the surfaces of the photodiodes located at the checking positions of the square lattice pattern inclined obliquely by 45° and the color filters C1, C2 are formed on the surfaces of the photodiodes located at the remaining checking positions. Namely, in the solid-state image pickup device, in the solid-state image pickup 48 illustrated in FIG. 15, in directions of oblique 45°, on the individual surfaces of the photodiodes, “C1, HG, C1, HG, C1, . . . ” and “C2, HG, C2, HG, C2, . . . ” are alternately arranged.

As that in FIG. 13, the arrangement of FIG. 15, when viewed from a different aspect, can be regarded as two square lattice patterns at equal pitches has been shifted from each other in the row and column directions by a ½ pitch. In such an aspect, on the surfaces of the photodiodes constituting the one square lattice pattern, the high sensitivity G filters HGs are arranged whereas on the surfaces of the photodiodes constituting the other square lattice pattern, the complementary color filters C1, C2 are arranged. In this example, the color complement filters C1 and C2 allowing magenta and yellow to pass through, respectively may be used.

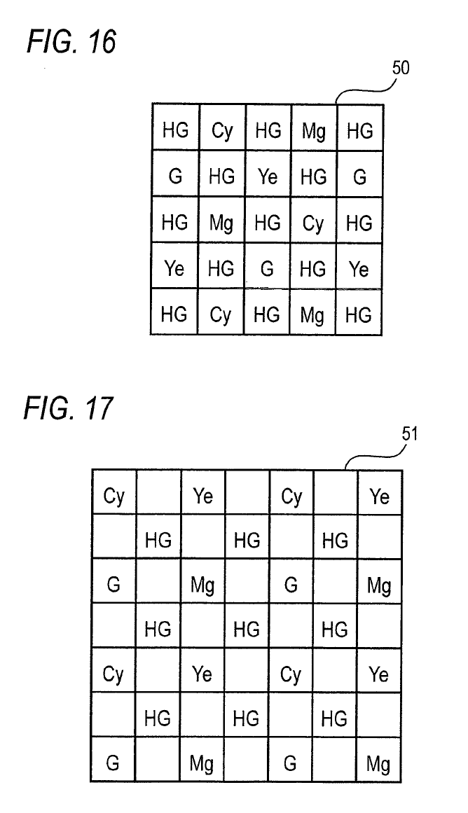

FIG. 16 is a schematic view of a light receiving area surface of the solid-state image pickup device according to a five embodiment of this invention. FIG. 16 illustrates only the range of five rows and five columns, but actually, the arrangement illustrated in FIG. 15 is repeated vertically and horizontally.

The light receiving area 50 of the solid-state image pickup device according to this embodiment includes high sensitivity G filters HGs and color complimentary filters G, Cy, Ye and Mg formed on the individual surfaces of a large number of photodiodes (not shown) formed from a matrix in a square lattice pattern. The high sensitive G filters HGs are formed on the surfaces of the photodiodes located at the checking positions of the individual photodiodes of the matrix. The color filters G, Cy, Ye and Mg are formed on the surfaces of the photodiodes located at the remaining checking positions.

Namely, in the solid-state image pick-up device illustrated in FIG. 16, the filters lined up like “HG, Cy, HG, Mg, HG . . . ” on the individual surfaces of the photodiodes at even rows and the filters lined up like “G, HG, Ye, HG, G, . . . ” on the individual surfaces of the photodiodes at odd rows are alternately arranged.

The high sensitivity G filters HGs are filters capable of simultaneously giving the brightness component and hue component of G, i.e. brightness/high sensitivity G filters. The high sensitivity G filters HGs can be realized by a thin material of the color filter 39G shown in FIG. 4A and FIG. 4B. The color filters Cy, Ye and MG are complimentary filters which pass cyan light, yellow light and magenta light, respectively. The color filter G is a filter which passes green light.

FIG. 17 is a schematic view of a light receiving area surface of the solid-state image pickup device according to a sixth embodiment of this invention. In the image pickup device shown in FIG. 17, like that shown in FIG. 13, the photodiodes are arranged to form the checkered pattern. FIG. 17 illustrates only the range of seven rows and seven columns, but actually, the arrangement illustrated in FIG. 17 is repeated vertically and horizontally.

The light receiving area 51 of the solid-state image pickup device according to this embodiment includes high sensitivity G filters HGs and color complementary filters G, Cy, Ye and Mg formed on the individual surfaces of a large number of photodiodes (not shown) arranged to form the checkered pattern. This arrangement, when it is inclined obliquely by 45°, constitutes an arrangement to form the square lattice pattern; the high sensitive G filters HGs are formed on the surfaces of the photodiodes located at the checking positions of the square lattice pattern inclined obliquely by 45° and the color filters G, Cy, Ye and Mg are formed on the surfaces of the photodiodes located at the remaining checking positions. Namely, in the solid-state image pickup device, in the solid-state image pickup 48 illustrated in FIG. 17, in directions of oblique 45°, on the individual surfaces of the photodiodes, “HG, Cy, HG, Mg, HG, . . . ” and “G, HG, Ye, HG, G, . . . ” are alternately arranged.

As that in FIG. 13, the arrangement of FIG. 17, when viewed from a different aspect, can be regarded as two square lattice patterns at equal pitches has been shifted from each other in the row and column directions by a ½ pitch. In such an aspect, on the surfaces of the photodiodes constituting the one square lattice pattern, the high sensitivity G filters HGs are arranged whereas on the surfaces of the photodiodes constituting the other square lattice pattern, the complementary color filters C, Cy, Ye and Mg are arranged. As that in FIG. 16, the color filters Cy Ye and Mg are complement filters allowing cyan, magenta and yellow to pass through, respectively. The color filter G is a filter allowing green

As described above, in accordance with the solid-state image pickup device, pixels dedicated to detect the brightness information and hue information are simultaneously provided. For this reason, the brightness and resolution of the image picked up will not greatly depend on the brightness and color of an image picked up object, thereby giving an excellent image.

In addition, the above description employs an arrangement in which the number of the high sensitivity G filters HGs is equal to the sum of the number of color filters R, G and B or the sum of the number of complementary color filters Cy, Mg and Ye. The arrangement is not limited thereto. Namely, the number of the high sensitivity G filters HGs may be larger than the sum of the number of color filters. On the contrary, the sum of the number of color filters may be larger than the number of the high sensitivity G filters HGs.

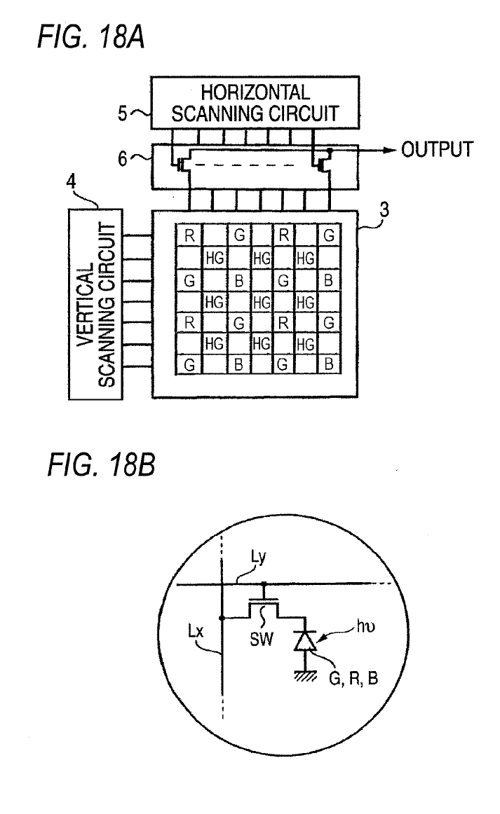

Next, referring to FIG. 18A and FIG. 18B, an explanation will be given of a concrete example of a MOS-type color image pickup device according to an embodiment of this invention. FIG. 18A and FIG. 18B show an example using photosensitive devices arranged to form the checkered pattern, but in place of them, solid-state image pickup elements arranged to form the square lattice pattern may be adopted. In FIG. 18A, the light receiving area 3 includes the high sensitivity G filters HGs giving the brightness component and the hue component of G and color filters R, G, B which are arranged to form the checkered pattern as shown in FIG. 13. Therefore, the photodiodes arranged below the respective filters serves as first photosensitive elements simultaneously giving the brightness component and the hue component and the hue photosensitive elements mainly giving the hue component.

These photosensitive elements (for brevity, hereinafter referred to as HG, G, R and B) may be formed of photosensitive elements themselves having the corresponding spectral sensitivity characteristics, or otherwise by stacking the color filters having the corresponding spectral sensitivity characteristics on the light receiving elements such as the photodiodes having the same photosensitivity characteristic.

For the light receiving area 3, a vertical scanning circuit 4, a horizontal scanning circuit 5 and a select circuit 6 are provided. Further, each photosensitive element HG, G, R, B, as seen from a conceptual view of FIG. 18B, is connected to a switching element SW provided between a select line Ly extended from the vertical scanning circuit 4 and an access line Lx extended from the select circuit 6.

The vertical scanning circuit 4 supplies a vertical scanning signal synchronous with a predetermined vertical scanning timing to each select line Ly to the photosensitive elements HG, G, R and B. The horizontal scanning circuit 5 successively turns on the switching elements in the select circuit 6 by a horizontal scanning signal synchronous with a predetermined horizontal scanning timing. Thus, each pixel signal generated in the photosensitive element HG, G, R, B selected by each select line Ly is read out externally through each access line Lx.

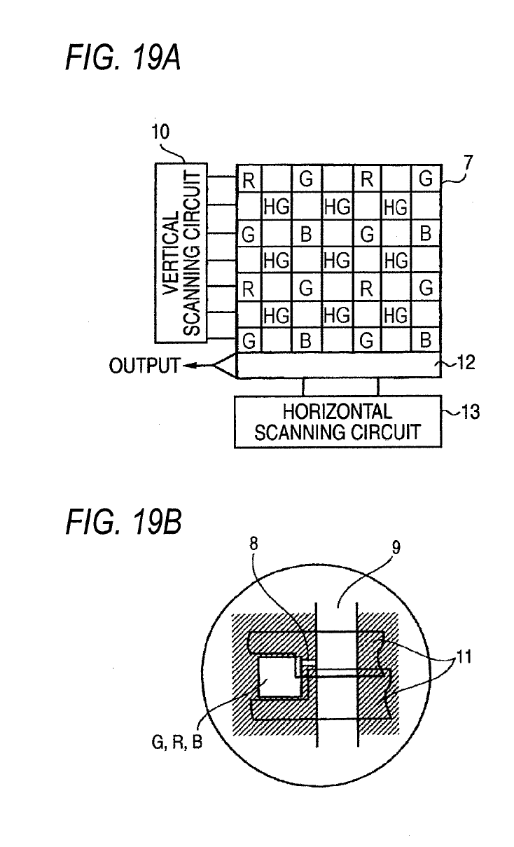

Next, referring to FIG. 19A and FIG. 19B, an explanation will be given of another concrete example of a CCD-type color image pickup device according to an embodiment of this invention. FIG. 19A and FIG. 19B show an example using photosensitive devices arranged to form the checkered pattern, but in place of them, solid-state image pickup elements arranged to form the square lattice pattern may be adopted. In FIG. 19A, the light receiving area 7 includes the high sensitivity G filters HGs giving the brightness component and the hue component of G and color filters R, G, B, which are arranged to form the checkered pattern as shown in FIG. 13. Therefore, the photodiodes arranged below the respective filters serves as first photosensitive elements simultaneously giving the brightness component and the hue component and the hue photosensitive elements mainly giving the hue component.

These photosensitive elements (for brevity, hereinafter referred to as HG, C, R and B) may be formed of photosensitive elements themselves having the corresponding spectral sensitivity characteristics, or otherwise by stacking the color filters having the corresponding spectral sensitivity characteristics on the light receiving elements such as the photodiodes having the same photosensitivity characteristic.

In this solid-state image pickup device, as seen from a conceptual view o FIG. 19B, a vertical charge transfer path 9 is formed adjacently to each photosensitive element HG, G, R, B through a transfer gate 8. On the upper surface of the vertical charge transfer 9, a large number of transfer electrodes 11 are stacked. In synchronism with a vertical transfer driving signal in e.g. a four-phase driving system supplied to a predetermined transfer electrode from a vertical transfer circuit 10, the pixel signal of each photosensitive element HG, G, R, B is vertically transferred by each vertical charge transfer path 9.

Further, at the end of each vertical charge transfer path 9, a horizontal charge transfer 12 is formed. Each pixel signal vertically transferred from each vertical charge transfer path 9 is horizontally transferred in synchronism with a horizontal transfer driving signal in e.g. a two-phase driving system supplied from a horizontal transfer circuit 13, thereby reading out the pixel signal.

An explanation will be given of the AF (Auto-Focus) operation where the solid-state image pickup device explained hitherto is applied to the digital camera shown in FIG. 1. The first photosensitive element (photosensitive element equipped with the high sensitivity G filter HG) forgiving the brightness component and hue component in the solid-state image pickup device according to this invention, even when there is less quantity of light from the object, produces a relatively large signal. For this reason, during the high sensitivity pick-up mode having generally less quantity of signal electric charges to be processed (when ISO sensitivity is increased for pickup with high sensitivity), only the first photosensitive element is used for AF control, thereby realizing the AF operation with high precision. It should be noted that such a switching of the AF control is performed by the system control unit 11.

What is claimed is:

1. A solid-state image pickup device comprising:
a plurality of photosensitive elements that are arranged to form a matrix pattern,
wherein the photosensitive elements includes:
first photosensitive elements that obtain simultaneously brightness components and hue components; and
second photosensitive elements that obtain hue components, and
the second photosensitive elements are hue photosensitive elements.

2. The solid-state image pickup device according to claim 1,
wherein the first photosensitive elements are arranged with a uniform density.

3. The solid-state image pickup device according to claim 1,
wherein each first photosensitive element has a spectral sensitivity over the entire visible light range, and
each first photosensitive element obtains the spectral sensitivity higher for green than for other colors.

4. The solid-state image pickup device according to claim 1,
wherein the hue photosensitive elements are a plurality of kinds of photosensitive elements with different spectral sensitivities.

5. The solid-state image pickup device according to claim 4,
wherein the plurality of kinds of photosensitive elements include a photosensitive element having a spectral sensitivity for magenta and a photosensitive element having the spectral sensitivity for yellow.

6. The solid-state image pickup device according to claim 4,
wherein the plurality of kinds of photosensitive elements include a photosensitive element having a spectral sensitivity for red, a photosensitive element having the spectral sensitivity for green and a photosensitive element having the spectral sensitivity for blue.

7. The solid-state image pickup device according to claim 4,
wherein the plurality of kinds of photosensitive elements include a photosensitive element having a spectral sensitivity for green, a photosensitive element having the spectral sensitivity for cyan, a photosensitive element having the spectral sensitivity for magenta and a photosensitive element having the spectral sensitivity for yellow.

8. The solid-state image pickup device according to claim 1, wherein
the hue photosensitive elements are photosensitive elements which sense light through color filters,
the first photosensitive elements are photosensitive elements which sense light through color filters of the same material as any one of the color filters of the first photosensitive elements, and
the film thickness of the color filter of each first photosensitive element is thinner than the color filter of each hue photosensitive element.

9. The solid-state image pickup device according to claim 1,
wherein the number of the first photosensitive elements is equal to that of the hue photosensitive elements.

10. The solid-state image pickup device according to claim 9, wherein
the plurality of photosensitive elements are arranged to form a square lattice pattern, and
the first photosensitive elements are arranged at checking positions of the square lattice pattern.

11. The solid-state image pickup device according to claim 9,
wherein the first photosensitive elements and the hue photosensitive elements are arranged to form square lattice patterns at equal pitches, respectively, and
the respective square lattice patterns are shifted from each other in the row and column directions by a ½ pitch.

12. The solid-state image pickup device according to claim 1,
wherein the solid-state image pickup device is a MOS type solid-state image pickup device.

13. The solid-state image pickup device according to claims 1,
wherein the solid-state image pickup device is a CCD type solid-state image pickup device.

14. An image pickup apparatus incorporating the solid-state image pickup device according to claim 1.

15. The image pickup apparatus according to claim 14,
wherein an autofocus operation is performed with signals obtained from the first photosensitive elements and without signals obtained from the hue photosensitive elements.
